(19) United States
(12) Patent Application Publication
(10) Pub. No.: US 2017/0077734 A1
(43) Pub. Date: Mar. 16, 2017

(54) POWER TRANSMISSION WITH WIRELESS TRANSCEIVER

(71) Applicant: Intel Corporation, Santa Clara, CA (US)

(72) Inventors: Erkki Nokkonen, Tampere (FI); Jaakko Isohella, Tampere (FI)

(73) Assignee: Intel Corporation, Santa Clara, CA (US)

(21) Appl. No.: 14/854,509

(22) Filed: Sep. 15, 2015

(51) Int. Cl. H02J 7/02; H02J 50/10; H02J 7/04

(52) U.S. Cl. CPC H02J 7/025; H02J 7/045; H02J 50/10

(57) ABSTRACT

An apparatus for power transmission with a wireless transceiver is described herein. The apparatus can include a power supply to generate a voltage and a current to flow through a power multiplexer and to a tuning antenna resonator. In this disclosure, the power multiplexer can switch between a receive mode and a transmit mode based on a signal from the processor. The tuning antenna resonator can transmit and receive power based on the power multiplexer.

### TECHNICAL FIELD

The present techniques relate generally to transmission of power. More specifically, the present techniques relate to transmission of power using wireless power technology.

### BACKGROUND ART

Mobile phones, tablets, smart watches, headsets, and other similar computing devices currently require electrical power to function. This power can be stored in a local battery or received from a connectable wire. Power transmission to a device and within a device can include transmission through conductive wires, metals, capacitors, and other power transmission circuits. Power can also be received wirelessly through the use of antennas.

### BRIEF DESCRIPTION OF THE DRAWINGS

FIG. 1 is a block diagram of an example system on chip (SoC) on a printed circuit board (PCB) for power transmission with a wireless transceiver;

FIG. 2 is a schematic diagram of a simplified example of an apparatus for power transmission with a wireless transceiver;

FIG. 3 is a block diagram of an example system of two units in corresponding transmitting and receiving modes;

FIG. 4 is a process flow diagram describing an example method for power transmission with a wireless transceiver;

FIG. 5 is a block diagram showing tangible, non-transitory computer-readable media that stores code for power transmission with a wireless transceiver; and

FIG. 6 is a simplified block diagram of an example circuit diagram for power transmission with a wireless transceiver.

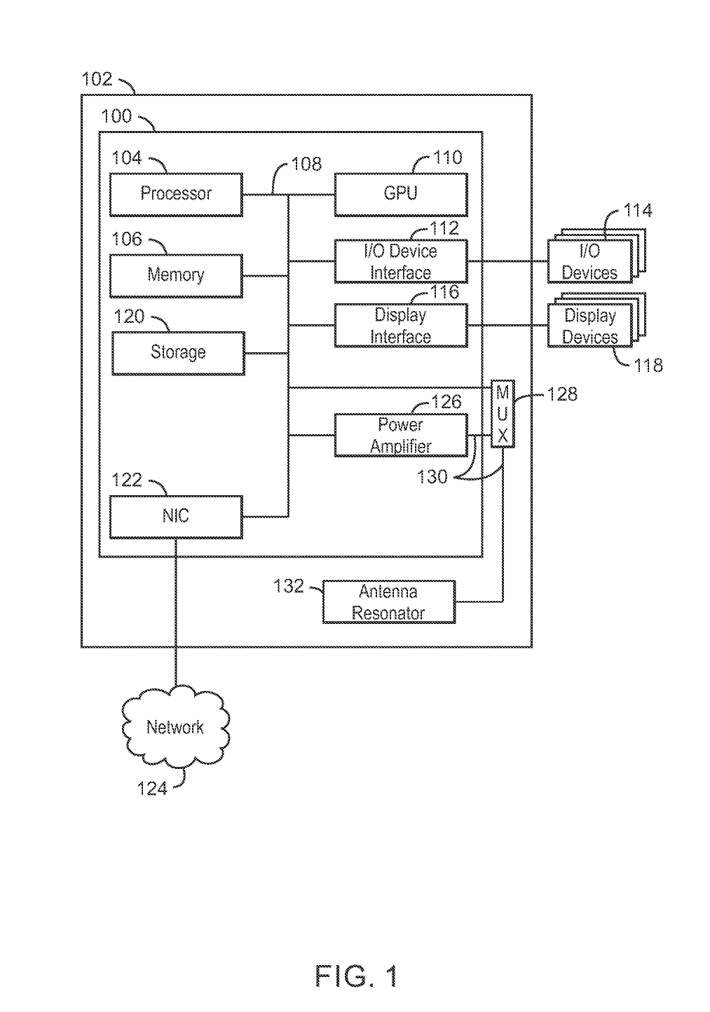

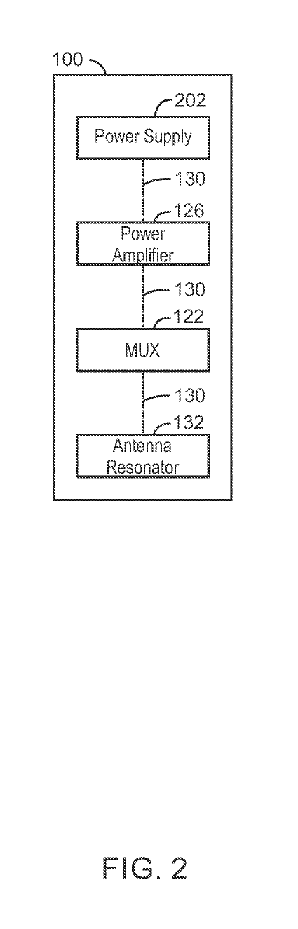

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Wireless charging devices can act as power receivers or transmitters. In the present disclosure, techniques for combining both wireless power transmission and receiving using the same hardware are discussed. For example, techniques are described for wirelessly charging a mobile device, e.g. a mobile phone, where the mobile device can be also used to charge another mobile device, e.g. an accessory such as a wireless headset.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It can be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As can become readily apparent in the description below, the embodiments of methods, apparatus', and systems described herein (whether in reference to hardware, firmware, software, or a combination thereof) are vital to a ‘green technology’ future balanced with performance considerations.

FIG. 1 is a block diagram of an example system on chip (SoC) on a printed circuit board (PCB) for power transmission with a wireless transceiver. The SoC 100 and PCB 102 may be components of, for example, a laptop computer, desktop computer, Ultrabook, tablet computer, mobile device, mobile phone, or server, among others. The SoC 100 may include a central processing unit (CPU) 104 that is configured to execute stored instructions, as well as a memory device 106 that stores instructions that are executable by the CPU 104. The CPU may be coupled to the memory device 106 by a bus 108. Additionally, the CPU 104 can be a single core processor, a multi-core processor, a computing cluster, or any number of other configurations. Furthermore, the SoC 100 may include more than one CPU 104.

The SoC 100 may also include a graphics processing unit (GPU) 110. As shown, the CPU 104 may be coupled through the bus 108 to the GPU 110. The GPU 110 may be configured to perform any number of graphics functions and actions. For example, the GPU 110 may be configured to render or manipulate graphics images, graphics frames, videos, or the like, to be displayed to a user of the SoC 100. The memory device 106 can include random access memory (RAM), read only memory (ROM), flash memory, or any other suitable memory systems. For example, the memory device 106 may include dynamic random access memory (DRAM).

The CPU 104 may be connected through the bus 108 to an input/output (I/O) device interface 112 configured to connect with one or more I/O devices 114. The I/O devices 114 may include, for example, a keyboard and a pointing device, wherein the pointing device may include a touchpad or a touchscreen, among others. The I/O devices 114 may be built-in components of a platform including the SoC 100, or may be devices that are externally connected to a platform including the SoC 100. In embodiments, the I/O devices 114 may be a keyboard or a pointing device that is coupled with the I/O device interface 112.

The CPU 104 may also be linked through the bus 108 to a display interface 116 configured to connect with one or more display devices 118. The display devices 118 may include a display screen that is a built-in component of a platform including the SoC 100. Examples of such a computing device include mobile computing devices, such as cell phones, tablets, 2-in-1 computers, notebook computers or the like. The display device 118 may also include a computer monitor, television, or projector, among others, that is externally connected to the SoC 100. In embodiments, the display devices 118 may be a DisplayPort device that is coupled with the display interface 116.

The SoC 100 may also be coupled with a storage device 120. The storage device may be a component located on the PCB 102. Additionally, the storage device 120 can be a physical memory such as a hard drive, an optical drive, a thumb drive, an array of drives, or any combinations thereof. The storage device 120 may also include remote storage drives. The SoC 100 may also include a network interface controller (NIC) 122 may be configured to connect the SoC 100 through the bus 108, various layers of the PCB 102, and components of the PCB 102 to a network 124. The network 124 may be a wide area network (WAN), local area network (LAN), or the Internet, among others.

The SoC 100 may also be coupled with a power amplifier 126. The power amplifier can modulate the amount of power transmitted from a power source. The amount of power can be controlled based on an input received from the processor 104 and previously retrieved from a storage 120, a network 124, or a user input captured by a receiver such as one of the I/O devices 114. The amount of power can also be controlled without user input but instead automatically based on a number of stored power settings, detected power level preferences, or other suitable means of adjusting a power level. In an example, one of the display devices 118 can prompt a user to provide input to the receiver by presenting a power mode option on one of the display devices 118. A power mode option can be a listing of a power level of a number of power levels including voltages, wattage, or other suitable measurements. In an example, the power mode option can be displayed in a user interface that a user can interact with. Based on this user input a power mode can be identified. The power mode can modulate a voltage provided by the power amplifier 126 and can also adjust a transmitting or a receiving mode of the SoC 100.

The SoC 100 can also be coupled to a multiplexer (MUX) 128. The MUX 128 may be used to select between various modes of transmission or receiving of power. This selection of mode can be based on received instructions from the processor that originated from memory 106, storage 120, network 124, I/O device 112 or any other suitable instruction insertion point. For example, the MUX 128 may be used to implement a receiving mode where the SoC 100 wirelessly receives power from an outside source. The MUX 128 can also be used to implement a transmitting mode where the SoC 100 wirelessly transmits power to an outside device or power store.

Internally the SoC 100 can move power through power conductors 130. In an example, power conductors 130 can be electrically conductive wires, traces, semi-conductive material, or through resonance or any other suitable product for power transmission. Although in FIG. 1, no power sources is explicitly shown, it can be implied and connects at least to the components shown, including the power amplifier 126 and the MUX 128. The power conductors 130 shown here indicate that a power current can travel through the lines for transmission, if in a transmission mode, or in to the SoC 100 if the SoC 100 receives power from an outside source in a receiving mode. The SoC 100 can include an antenna resonator 132 coupled with at least a power conductor 130 to the MUX 128. The antenna resonator 132 can resonate at a frequency that can match a second antenna resonator to receive or transmit power. The antenna resonator 132 can be a coil of wire which generates a magnetic field, a metal plate which generates an electric field, or an antenna which radiates radio waves. In an example, a second antenna resonator, or the antenna resonator 132 in a receiving mode can convert an oscillating field generated by an antenna resonator into an electric current.

It is to be understood that the block diagram of FIG. 1 is not intended to indicate that the SoC 100 is to include all of the components shown in FIG. 1. Rather, the SoC 100 can include fewer or additional components not illustrated in FIG. 1. Furthermore, the components may be coupled to one another according to any suitable system architecture, including the system architecture shown in FIG. 1 or any other suitable system architecture that uses a data bus to facilitate communications between components. For example, embodiments of the present techniques can also be implemented any suitable electronic device, including ultra-compact form factor devices, such as SoC and multi-chip modules. The present techniques may also be used on any electrical cable inside or outside of a computer that is used to carry digital information from one point to another.

FIG. 2 is a schematic diagram of a simplified example of an apparatus 200 for power transmission with a wireless transceiver. Like numbered items are as described in FIG. 1.

The SoC 100 can include a power supply 202 to provide a voltage and generate a current for anything connected by conductive materials. In an example, the power conductors 130, can be coupled to the power supply 202 to transmit power throughout the SoC 100. While the power conductors are shown connecting the power supply 202 to the power amplifier 126, to the MUX 128, to the antenna resonator 132, many other combinations can also be made. Rather than connecting these items in series, they can be connected to a power supply 202 in parallel and can also be part of a completely separate circuit. Further, while power conductors 130 shown here connect a subset of the items of FIG. 2, other items including the processor 104 and the NIC 122 can also draw power from the power supply 202 or another unseen power source.

In an example the power supply 202 can be a mobile voltage generator, such as a battery, entirely contained on the SoC 100 or adjacent to the SoC on the PCB 102. In an example, the power source 202 is not a power store, like a battery, but instead can be a live source such as a power supply unit receiving mains alternating current (AC). Any combination of power source can be used depending on the function of the SoC. Due to the SoC 100 having the ability to wirelessly receive and transmit power, some examples can include a mobile battery as a power supply 202 without a need for a static wire connection to an external power source. In an example, the SoC 100 in transmit mode can be used to provide power or charge a dormant accessory if that accessory had a suitable corresponding system for resonating with the antenna resonator 132 of the SoC 100. The charging or powering of an accessory or other device can be a user selectable feature, activated on the device UI. The charging or powering of an accessory can be established by an automatic pairing of accessories or other devices through out-of-band communications like Bluetooth so that whenever in range, the devices can start power transfer automatically.

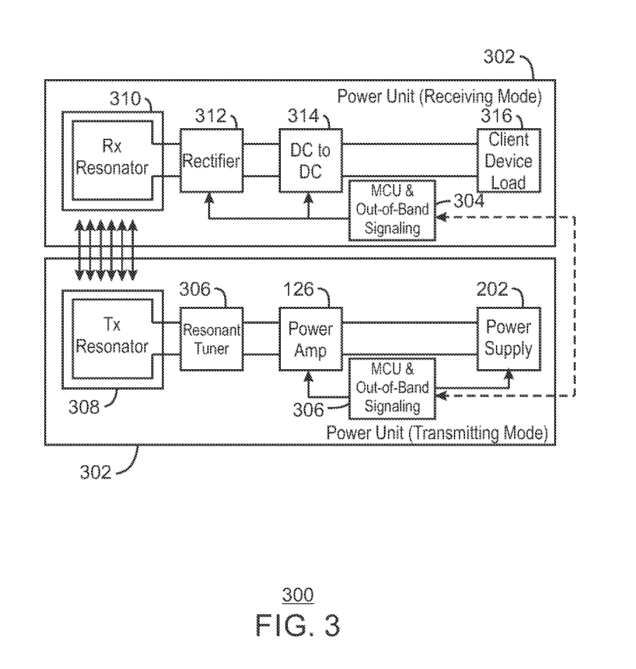

FIG. 3 is a block diagram of an example system of two units in corresponding transmitting and receiving modes. Like numbered items are as described above in FIG. 1 and FIG. 2.

Each power unit 302 can be in one of two modes, transmitting mode or receiving mode. In FIG. 3, the lower power unit 302 appears in transmitting mode with the items for transmitting shown. The upper power unit 302 appears in receiving mode with the items for receiving shown. While each power unit 302 shows different items for various features, each of the items in either power unit 302 are present in both power units 302 although may not be shown here for simplicity of understanding the method of power transfer.

The power unit can include a power supply 202 to transmit power to a power amplifier 126 based on input delivered by a microcontroller (MCU) and prior out-of-band signaling 304 between the transmitting mode power unit 302 and the receiving mode power unit 302. When a proper power passes from the power amp 126 in transmitting mode, it can pass through a resonant tuner 306. The resonant tuner 306 can tune a connected transmission (Tx) mode resonator 308 into resonance using a capacitor and resonance tuning techniques. In FIG. 3, the Tx mode resonator 308 can transmit power to an RX Resonator 310 in a second power unit 302. The frequency a Tx resonator 308 transmits at can be based on a resonant coupling frequency to allow the transfer of power wirelessly from one resonator to another. In FIG. 3, a resonant coupling from the Tx resonator 308 to a resonator for receiving (Rx) can be measured in hertz (Hz), for example, 6.78 MHz.

A Rx resonator 310 of a power unit 302 in receiving mode can resonate with the Tx resonator 308 of the power unit 302 in receiving mode. Electrical power generated from the resonance of the Rx resonator 310 can pass through a rectifier 312, a direct current (DC) to DC converter 314, to reach the client device load 316. A rectifier 312 can convert alternating current (AC) to direct current (DC) and can be a copper and selenium oxide rectifier, a semiconductor diodes, silicon-controlled rectifiers and other silicon-based semiconductor switches, or other suitable type of rectifier 312. The DC to DC converter 314 can alter a received voltage to a level needed by a client device load 316.

The power units 302 can each alternate between receiving and transmitting mode and each has the above described items. In examples, one power unit 302 can have a different resonator that cannot modulate a frequency. This power unit 302 can communicate the resonant coupling frequency of the Rx resonator 310 and a Tx resonator 308 can be tuned by a resonant tuner 306 to match. This resonant coupling frequency can be communicated out-of-band, for example, through a wireless bidirectional communication operating at 2.4 GHz frequency shown in FIG. 3 connecting the MCU and out-of-band signaling 304.

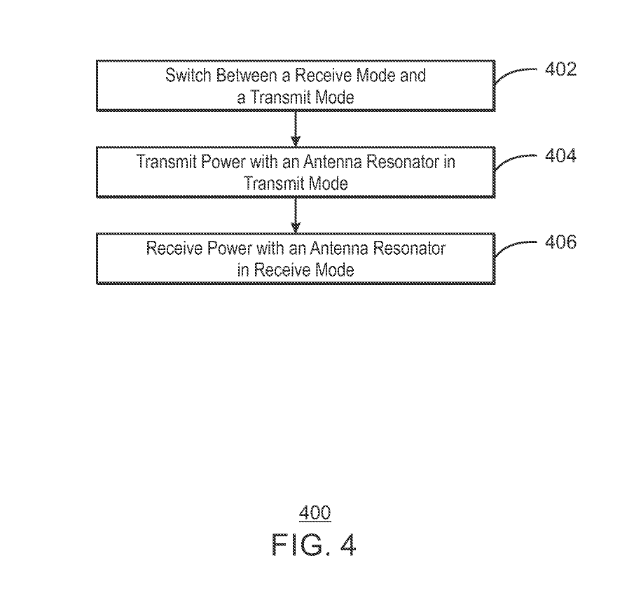

FIG. 4 is a process flow diagram describing an example method for power transmission with a wireless transceiver. Process flow can begin at block 402.

At block 402 a device with a wireless receiver, such as an antenna resonator, can be switched between a receive mode and a transmit mode. In an example, the switching of setting to enable these modes can involve a power multiplexer to switch between modes based on instructions received from a processor and originally from user input.

At block 404, an antenna resonator of the device can be used to transmit power wirelessly, when the device is in transmit mode. The transmission of power in transmission mode can include matching a receiving antenna's resonant frequency. In an example, the resonant frequency may not be automatically supplied, and the device can request, through digital and wireless signaling, the power receiving device to communicate back a resonant frequency to tune to.

At block 406, the device can receive power with an antenna resonator in a receive mode. In an example, the device can detect a nearby second device that can transmit power through an antenna resonator and can have the device transmit a signal including the resonant frequency of the antenna so that a transmitting device can tune to that particular frequency. The power received while in receive mode can be used on a device load, including running a processor. The power received can also be stored in a rechargeable battery to be later discharged and the power retransmitted once the receive mode has switched to transmit mode.

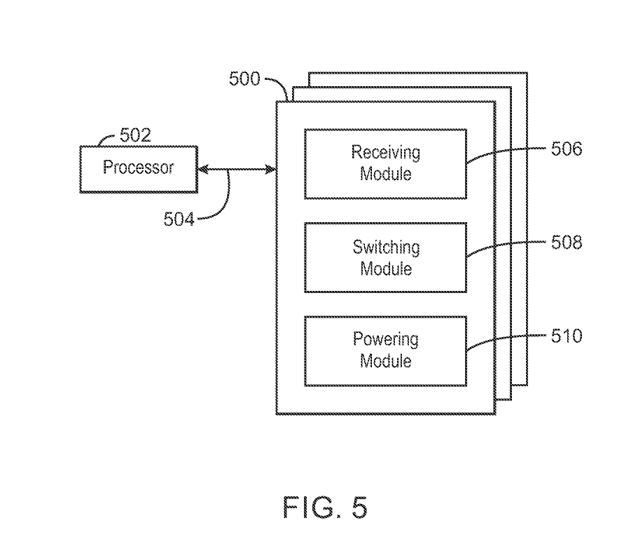

FIG. 5 is a block diagram showing tangible, non-transitory computer-readable media that stores code for power transmission with a wireless transceiver. The tangible, non-transitory computer-readable media 500 may be accessed by a processor 502 over a computer bus 504. Furthermore, the tangible, non-transitory computer-readable medium 500 may include code configured to direct the processor 502 to perform the methods described herein.

The various software components discussed herein may be stored on one or more tangible, non-transitory computer-readable media 500, as indicated in FIG. 5. For example, a receiving module 506 can receive user input to indicate a power mode option selection, for example, or a mode selection between receiving mode and transmitting mode. A switching module 508 can switch a computer-readable media 500 to between a receiving mode and a transmitting mode and can use a multiplexer to perform this switching. A powering module 510 can either provide power to an antenna resonator from a power supply to be transmitted wirelessly or the powering module can receive and direct power received by the antenna resonator when the computer-readable media 500 is in a receive mode.

The block diagram of FIG. 5 is not intended to indicate that the tangible, non-transitory computer-readable media 500 is to include all of the components shown in FIG. 5. Further, the tangible, non-transitory computer-readable media 500 may include any number of additional components not shown in FIG. 5, depending on the details of the specific implementation.

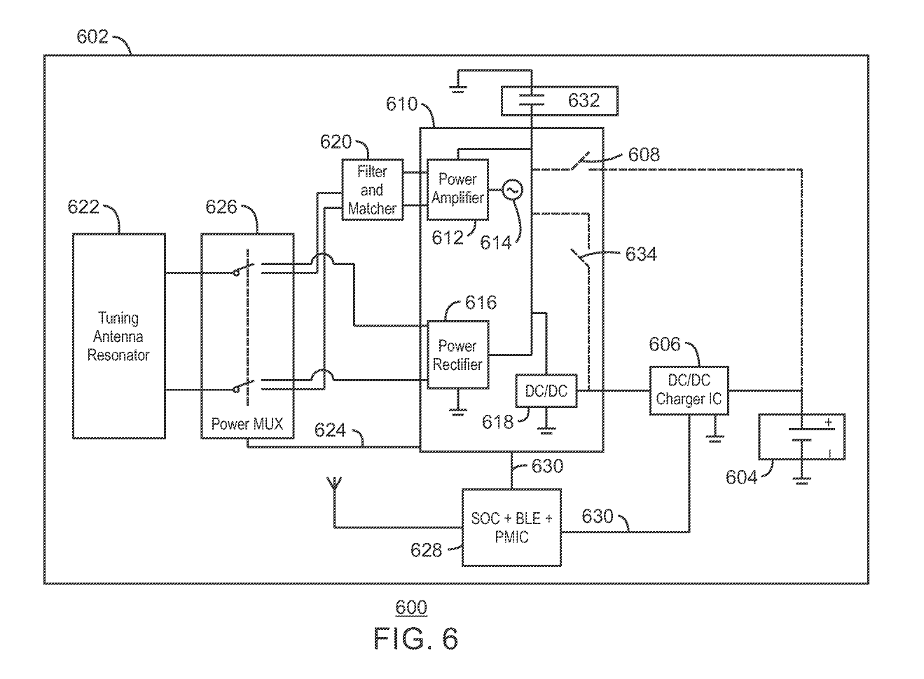

FIG. 6 is a simplified block diagram of an example circuit diagram for a system 600 for power transmission with a wireless transceiver. As shown in FIG. 6, system 600 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 6 is intended to show a high level view of many components of the system 600. However, it is to be understood that some of the components shown may be omitted, additional components may be present, and different arrangement of the components shown may occur in other implementations. As a result, the invention described above may be implemented in any portion of one or more of the interconnects illustrated or described below.

As discussed above, FIG. 6 shows a computing device 602 for power transmission with a wireless transceiver. The device can be a mobile phone, tablet, watch, glasses, or any other suitable computing device that can receive power wirelessly.

The computing device 602 can include a power supply, here a battery 604. The battery can be coupled through an inductor to allow current to reach a DC-to-DC converter 606. In an example, the DC-to-DC 606 converter can be a charger IC to allow the modulation of voltages flowing from or to the battery 604. A connection can also be made from the battery 604 through the switch 608 to control, in part, current flow during lower power mode.

The DC-to-DC (charger IC) 606 can also connect to a device power transceiver 610 (DPT) including a power receiver unit (PRU) & a power transmitter unit (PTU). The DPT 610 can include a power amplifier 612 and an AC voltage source 614 to provide voltage at a frequency, for example, 6.78 MHz to a power amplifier and its control. The power amplifier 612 can be operated for example in a push-pull configuration. Furthermore, the DPT 610 can include a power rectifier 616 and a DC-to-DC converter 618.

The DPT 610 can be coupled to filtering & matching circuit 620 which can include an electromagnetic filter, a harmonic filter, or any other suitable filter for reducing power disturbances and matching power amplifier to the tuning antenna resonator 622. The tuning antenna resonator can be an antenna 308 and can also be the antenna resonator 132 as described above, or any other suitable wireless transmission device. Harmonic filtering can include any passive, active, or hybrid filtering to smooth out harmonics in a non-linear load, a current-distortion, or a voltage distortion.

The switching between modes can be accomplished by the signal traveling through a mode selection channel 624 to one or several power multiplexers (MUX) 626. In FIG. 6, one power MUX is shown, and it can include switches to be selectively closed to alter the mode from a receiving mode by allowing current to travel towards the battery 604 or a transmitting mode where current flows away from the battery 604 and DPT 610 and towards the tuning antenna resonator 622. In an example, the tuning antenna resonator 622 includes the resonance tuning circuitry.

Any instructions, input, and processing for the computing device can take place at the SoC, BLE, and power management integrated circuit (PMIC) 628 and can be communicated through control signal lines 630. Further, instructions can arrive or be sent through an out-of-band communicator including a Bluetooth Low energy (BLE) item to provide a power transfer communication link between one computing device 602 and another. This communication can allow the tuning antenna resonator 622 to be tuned into resonance. In an example, the tuning antenna resonator 622 can comply with the alliance for wireless power (A4WP) standard.

When the computing device 602 is in receiving mode (Rx mode), a power mux 626 controlled by the mode selection channel 624 can route power generated at the tuning antenna resonator 622 to the rectifier circuit 616 in DPT 610. The output voltage from the power rectifier 616 (Vrect), known also as a rectified voltage, can be smoothed by capacitor 632 connected to the DPT 610. From this capacitor 632 a smooth charge can travel through the DC-to-DC converter 618 through the battery charger IC 606, and to the battery 604 for storage. In an example, the DC-to-DC converter 618 may be omitted, by-passed, or replaced by a battery charger IC that can use rectifier output Vrect directly by use of a direct switch 634 without being lowered by DC-to-DC conversion. The output voltage from a rectifier, Vrect, can be via DC-to-DC 618 feeding a charger IC 606, when the charger IC can no longer accept Vrect voltage level directly. Vrect can also flow directly to charger IC 606. Vrect can deliver power via by-passed DC-to-DC converter 618 to charger IC 606.

When the computing device 602 is in transmitting mode (Tx mode) the power mux 626 can route output of the power amplifier 612 to the tuning antenna resonator 622 through filtering & matching Filter and Matcher 620 including electromagnetic interference (EMI) filtering and harmonic filtering. EMI filtering can include the use of bypass or decoupling capacitors, rise time control of high speed signals using series resistors, power supply filtering, or any other suitable means of avoiding disturbances caused by induction or radiation to the computing system 602. The power amplifier 612 can be powered by Vrect, which in Tx mode is derived from battery voltage.

When in Tx mode, a voltage can be generated, by a voltage generator such as the battery 604, to the rectifier capacitor 632 Crect near the DPT 610. The voltage generated to Crect can be used as a supply voltage, Vrect, for the power amplifier. In an example, the voltage can be supplied so that 6.78 MHz AC current can flow through the power mux 626 and arrive at the tuning antenna resonator 622. In a transmitting mode, the power amplifier inside DPT can be alternately driven using the AC voltage source 614 set to a particular frequency e.g. 6.78 MHz. In an example, the computing device 602 may act like a PTU and can follow an existing communication protocol defined by the A4WP standard so that the computing device 602 looks like a PTU. In an example, this can allow a Bluetooth headset to be charged or powered by the computing device 602 disclosed without any modification.

As far as the voltage generated and transmitted while a computing device 602 is in transmitting mode, a number of power modes and can be included in an apparatus or device. These power modes can be selectable by a user or automatically generated. These power modes can set a level of a supply voltage for a power amplifier and can be sent by a processor. The selected mode can be based on an amount of power to be transferred. In an example where a second device requests low power, the voltage supply could be battery 604 voltage (VBAT) directly. To enable this, a switch 608 can be used to transfer low power from the battery 604 to the power amplifier 612 and finally to the tuning antenna resonator 622. In an example where a second device requests medium power, a battery voltage may need to be boosted. The boosting of voltage supplied to the power amplifier and antenna can use an existing universal serial bus (USB) on-the-go (OTG) boost mode of a battery charger IC and connect a higher voltage to the capacitor 632 Crect near the DPT 610 using a by-pass voltage path 634 of the DC-to-DC converter 618. In an example where a second device requests an even higher power, a computing system 602 could include OTG boost mode of the battery charger IC 606 and also operate the DC-to-DC converter 618 in reverse boost mode to raise the voltage rather than lower it. In another example, the battery Charger IC 606 can boost the voltage directly without the DC-to-DC converter 618. In an example, the voltage can be dynamically adjusted e.g. between 5V to 20V by adding a mode to the DC-to-DC converter 606 or 618 allowing that DC-to-DC converter to supply the optimum voltage level.

### EXAMPLES

Example 1 is an apparatus for power transmission with a wireless transceiver. The apparatus includes a processor; a power supply to supply a voltage to a power amplifier; the power amplifier to generate a current to flow through a power multiplexer to a tuning antenna resonator; the power multiplexer to switch between a receive mode and a transmit mode based on a signal from the processor; and the tuning antenna resonator to switch between transmitting and receiving power based on the power multiplexer.

Example 2 includes the apparatus of example 1, including or excluding optional features. In this example, the power amplifier adjusts a supply voltage between a number of power modes, based on a signal from the processor. Optionally, the power modes can be one of a low power, a medium power, and a high power mode.

Example 3 includes the apparatus of any one of examples 1 to 2, including or excluding optional features. In this example, the apparatus includes a resonant tuner to match the tuning antenna resonator to a resonant coupling frequency.

Example 4 includes the apparatus of any one of examples 1 to 3, including or excluding optional features. In this example, the power transmitted in a transmitting mode is filtered by an electromagnetic filter.

Example 5 includes the apparatus of any one of examples 1 to 4, including or excluding optional features. In this example, the power transmitted in a transmitting mode is filtered by a harmonic filter.

Example 6 includes the apparatus of any one of examples 1 to 5, including or excluding optional features. In this example, the apparatus includes a direct current to direct current converter to modify the voltage supplied by the power supply.

Example 7 includes the apparatus of any one of examples 1 to 6, including or excluding optional features. In this example, the power supply comprises a voltage generator and a rectifier capacitor to generate a rectified voltage for the power amplifier.

Example 8 includes the apparatus of any one of examples 1 to 7, including or excluding optional features. In this example, the tuning antenna resonator is compliant with the alliance for wireless power (A4WP) standard.

Example 9 is a method for power transmission with a wireless transceiver. The method includes switching between a receive mode and a transmit mode based on a signal from a processor; transmitting power with a tuning antenna resonator is in transmit mode; and receiving power with a tuning antenna resonator is in receive mode.

Example 10 includes the method of example 9, including or excluding optional features. In this example, the power amplifier adjusts a supply voltage between a number of power modes, based on a signal from the processor. Optionally, the power modes can be one of a low power, a medium power, and a high power mode.

Example 11 includes the method of any one of examples 9 to 10, including or excluding optional features. In this example, the method includes matching the tuning antenna resonator to a resonant coupling frequency with a resonant tuner. Optionally, the power flowing through a power multiplexer and to the tuning antenna resonator is filtered by an electromagnetic filter. Optionally, the power flowing through a power multiplexer and to the tuning antenna resonator is filtered by a harmonic filter.

Example 12 includes the method of any one of examples 9 to 11, including or excluding optional features. In this example, the method includes modifying power supplied by a power supply with a direct current to direct current converter.

Example 13 includes the method of any one of examples 9 to 12, including or excluding optional features. In this example, a power supply comprises a voltage generator and a rectifier capacitor to generate a rectified voltage for the power amplifier.

Example 14 includes the method of any one of examples 9 to 13, including or excluding optional features. In this example, the tuning antenna resonator is compliant with the alliance for wireless power (A4WP) standard.

Example 15 is a system for power transmission with a wireless transceiver. The system includes a processor; a display to present a power mode option to a user; a receiver to receive user input from the user; a power supply to supply a voltage to a power amplifier; the power amplifier to generate a voltage and current to flow through a power multiplexer to a tuning antenna resonator; the power multiplexer to switch between a receive mode and a transmit mode based on the user input; and the tuning antenna resonator to transmit and receive power based on the power multiplexer.

Example 16 includes the system of example 15, including or excluding optional features. In this example, the power amplifier adjusts a supply voltage between a number of power modes, based on a signal from the processor.

Example 17 includes the system of any one of examples 15 to 16, including or excluding optional features. In this example, the system includes a resonant tuner to match the tuning antenna to a resonant coupling frequency. Optionally, the power is filtered by an electromagnetic filter. Optionally, the power is filtered by a harmonic filter.

Example 18 includes the system of any one of examples 15 to 17, including or excluding optional features. In this example, the system includes a direct current to direct current converter to modify the voltage supplied by the power supply.

Example 19 includes the system of any one of examples 15 to 18, including or excluding optional features. In this example, the power supply comprises a voltage generator and a rectifier capacitor to generate a rectified voltage for the power amplifier.

Example 20 includes the system of any one of examples 15 to 19, including or excluding optional features. In this example, the tuning antenna resonator is compliant with the alliance for wireless power (A4WP) standard.

Example 21 includes the system of any one of examples 15 to 20, including or excluding optional features. In this example, the display shows power level options comprising different voltage options; the receiver receives a user input for power level; and the voltage source modulates the battery voltage output, a boost mode of a battery charger, and a direct current to direct current converter based on the user input for power level.

Example 22 is a computing device for power transmission with a wireless transceiver. The computing device includes a processor; a means to present a power mode option to a user; a means to receive user input from the user; a means to supply a voltage to a power amplifier; the power amplifier to generate a voltage and current to flow through a power multiplexer to a tuning antenna resonator; the power multiplexer to switch between a receive mode and a transmit mode based on the user input; and the tuning antenna resonator to transmit and receive power based on the power multiplexer.

Example 23 includes the computing device of example 22, including or excluding optional features. In this example, the power amplifier adjusts a supply voltage between a number of power modes, based on a signal from the processor. Optionally, the power modes can be one of a low power, a medium power, and a high power mode.

Example 24 includes the computing device of any one of examples 22 to 23, including or excluding optional features. In this example, the computing device includes a resonant tuner to match the tuning antenna to a resonant coupling frequency. Optionally, the power is filtered by an electromagnetic filter. Optionally, the power is filtered by a harmonic filter.

Example 25 includes the computing device of any one of examples 22 to 24, including or excluding optional features. In this example, the computing device includes a direct current to direct current converter to modify the voltage supplied by the power supply.

Example 26 includes the computing device of any one of examples 22 to 25, including or excluding optional features. In this example, the power supply comprises a voltage generator and a rectifier capacitor to generate a rectified voltage for the power amplifier.

Example 27 includes the computing device of any one of examples 22 to 26, including or excluding optional features. In this example, the tuning antenna resonator is compliant with the alliance for wireless power (A4WP) standard.

Example 28 includes the computing device of any one of examples 22 to 27, including or excluding optional features. In this example, the means to present a power mode option shows power level options comprising different voltage options; the means to receive a user input, receives a user input for power level; and the means to supply a voltage modulates the battery voltage output, a boost mode of a battery charger, and a direct current to direct current converter based on the user input for power level.

Example 29 is a tangible, non-transitory, computer-readable medium. The computer-readable medium includes instructions that direct the processor to switch between a receive mode and a transmit mode based on a signal from a processor; transmit power with a tuning antenna resonator is in transmit mode; and receive power with a tuning antenna resonator is in receive mode.

Example 30 includes the computer-readable medium of example 29, including or excluding optional features. In this example, the computer-readable medium includes instructions that direct the processor to match the tuning antenna resonator to a resonant coupling frequency with a resonant tuner. Optionally, the power flowing through a power multiplexer and to the tuning antenna resonator is filtered by an electromagnetic filter. Optionally, the power flowing through a power multiplexer and to the tuning antenna resonator is filtered by a harmonic filter.

Example 31 includes the computer-readable medium of any one of examples 29 to 30, including or excluding optional features. In this example, the computer-readable medium includes instructions that direct the processor to modify power supplied by a power supply with a direct current to direct current converter.

Example 32 includes the computer-readable medium of any one of examples 29 to 31, including or excluding optional features. In this example, a power supply comprises a voltage generator and a rectifier capacitor to generate a rectified voltage for the power amplifier.

Example 33 includes the computer-readable medium of any one of examples 29 to 32, including or excluding optional features. In this example, the tuning antenna resonator is compliant with the alliance for wireless power (A4WP) standard.

Example 34 includes the computer-readable medium of any one of examples 29 to 33, including or excluding optional features. In this example, the power amplifier adjusts a supply voltage between a number of power modes, based on a signal from the processor.

Example 35 includes the computer-readable medium of any one of examples 29 to 34, including or excluding optional features. In this example, the power modes can be one of a low power, a medium power, and a high power mode.

Example 36 includes the computer-readable medium of any one of examples 29 to 35, including or excluding optional features. In this example, the computer-readable medium includes instructions that direct the processor to use a direct current to direct current converter to modify the voltage supplied by the power supply.

Example 37 includes the computer-readable medium of any one of examples 29 to 36, including or excluding optional features. In this example, the computer-readable medium includes instructions that direct the processor to use an out-of-band signaling method to send and receive instructions on a power mode voltage.

Example 38 includes the computer-readable medium of any one of examples 29 to 37, including or excluding optional features. In this example, the computer-readable medium includes instructions that direct the processor to detect a second device within power transmission range and receive a signal indicating if the tuning antenna resonator should transmit power.

Example 39 includes the computer-readable medium of any one of examples 29 to 38, including or excluding optional features. In this example, the computer-readable medium includes instructions that direct the processor to assign a preference for power transmission and receiving methods enabling a wired method before receiving or transmitting power wirelessly.

While the present techniques have been described with respect to a limited number of embodiments, those skilled in the art can appreciate numerous modifications and variations therefrom. It is intended that the appended claims cover all such modifications and variations as fall within the true spirit and scope of this present techniques.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present techniques may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

In the foregoing specification, a detailed description has been given with reference to specific exemplary embodiments. It can, however, be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus for power transmission with a wireless transceiver, comprising:
a processor;
a power supply to supply a voltage and current to flow through a power multiplexer to a tuning antenna resonator;
wherein the power multiplexer is configured to switch between a receive mode and a transmit mode based on a signal from the processor; and
wherein the tuning antenna resonator is configured to switch between transmitting and receiving power based on the receive or transmit mode.

2. The apparatus of claim 1, wherein a power amplifier is configured to adjust a supply voltage between a plurality of power modes, based on a signal from the processor.

3. The apparatus of claim 2, wherein the plurality of power modes is a low power, a medium power, or a high power mode.

4. The apparatus of claim 1, further comprising a resonant tuner configured to match the tuning antenna resonator to a resonant coupling frequency.

5. The apparatus of claim 4, wherein the power transmitted in a transmitting mode is filtered by an electromagnetic filter.

6. The apparatus of claim 4, wherein the power transmitted in a transmitting mode is filtered by a harmonic filter.

7. The apparatus of claim 1, further comprising a direct current to direct current converter configured to modify the voltage supplied by the power supply.

8. The apparatus of claim 1, wherein the power supply comprises a voltage generator and a rectifier capacitor configured to generate a rectified voltage for a power amplifier.

9. The apparatus of claim 1, wherein the tuning antenna resonator is compliant with the alliance for wireless power (A4WP) standard.

10. A method for power transmission with a wireless transceiver, comprising:
switching between a receive mode and a transmit mode based on a signal from a processor;
transmitting power with a tuning antenna resonator in the transmit mode; and
receiving power with a tuning antenna resonator in the receive mode.

11. The method of claim 10, comprising matching the tuning antenna resonator to a resonant coupling frequency with a resonant tuner.

12. The method of claim 11, further comprising filtering the power flowing through a power multiplexer and to the tuning antenna resonator with an electromagnetic filter.

13. The method of claim 11, further comprising filtering the power flowing through a power multiplexer and to the tuning antenna resonator with a harmonic filter.

14. The method of claim 10, comprising modifying power supplied by a power supply with a direct current to direct current converter.

15. The method of claim 14, wherein the power supply comprises a voltage generator and a rectifier capacitor to generate a rectified voltage for a power amplifier.

16. The method of claim 10, wherein the tuning antenna resonator is compliant with the alliance for wireless power (A4WP) standard.

17. A system for power transmission with a wireless transceiver, comprising:
a processor;
a display to present a power mode option to a user;
a receiver to receive user input from the user;
a power supply to supply a voltage and current to flow through a power multiplexer to a tuning antenna resonator;
the power multiplexer to switch between a receive mode and a transmit mode based on the user input; and
the tuning antenna resonator to transmit and receive power based on the receive or transmit mode.

18. The system of claim 17, further comprising a power amplifier configured to adjust a supply voltage between a plurality of power modes, based on a signal from the processor.

19. The system of claim 17, further comprising a resonant tuner to match the tuning antenna to a resonant coupling frequency.

20. The system of claim 19, wherein the power is filtered by an electromagnetic filter.

21. The system of claim 19, wherein the power is filtered by a harmonic filter.

22. The system of claim 17, comprising a direct current to direct current converter to modify the voltage supplied by the power supply.

23. The system of claim 17, wherein the power supply comprises a voltage generator and a rectifier capacitor to generate a rectified voltage for a power amplifier.

24. The system of claim 17, wherein the tuning antenna resonator is compliant with the alliance for wireless power (A4WP) standard.

25. The system of claim 17, wherein:
the display is configured to show power level options comprising different voltage options;
the receiver configured to receive a user input for power level; and
the voltage source configured to modulate the battery voltage output, a boost mode of a battery charger, and a direct current to direct current converter based on the user input for power level.
